(19) United States
(12) Patent Application Publication
(10) Pub. No.: US 2006/0177041 A1
(43) Pub. Date: Aug. 10, 2006

(54) METHOD AND SYSTEM TO PROJECT STAFFING NEEDS USING PREDICTIVE MODELING

(76) Inventors: Michael Warner, Chapel Hill, NC (US); Beth Pickard, Hillsborough, NC (US); Kate Nell, Raleigh, NC (US)

Correspondence Address: MOORE & VAN ALLEN PLLC, P.O. BOX 13706, Research Triangle Park, NC, 27709, US

(21) Appl. No.: 10/906,145

(22) Filed: Feb. 4, 2005

(51) Int. Cl. H04M 3/00

(52) U.S. Cl. 379/266.08

(57) ABSTRACT

A method to project staffing needs may include predetermining an optimal prediction method for predicting staffing needs from a plurality of prediction methods based on at least one of a center, a target day in a forecasting horizon and a time interval using historical data. The method may also include predicting future staffing needs for at least one of a selected center, a selected target day and a selected time interval by using the predetermined optimal prediction method for the at least one of selected center, selected target day and selected time interval.

### COPYRIGHT NOTICE

A portion of the disclosure of this patent document contains material that is subject to copyright protection. The copyright owner has no objection to the facsimile reproduction by anyone of the patent document, or the patent disclosure, as it appears in the Patent and Trademark Office patent files or records, but otherwise reserves all copyright rights whatsoever.

### BACKGROUND OF INVENTION

The present invention relates to projecting the need for staff and the deployment of staff to meet that need and more particularly to a method and system to project staffing needs using predictive modeling which may be combined with a method and system for staffing decision-makers to follow that enhances staff management.

Staffing decisions are typically made at the last minute (for the next shift or day) in a chaotic environment, such as a health care facility, restaurant, hotel, call center or similar environment or industry that requires efficient, cost effect staffing to operate and control costs. Ineffective staffing of staff members can result in overstaffing or understaffing or staffing with inappropriate types of skills. All can have adverse affects. Overstaffing will result in higher operating costs. Understaffing may result in being unable to provide the needed services or products which can result in serious consequences in a health care environment. Staffing with inappropriate types of skills can also result in being unable to provide needed services or care that may result in adverse consequences. Being able to accurately predict staffing needs and types of staff skills in the future can reduce tension and stress. Additionally, accurate staffing and scheduling permits staff members to better plan their personal lives. This can lead to higher staff satisfaction, loyalty and morale.

### SUMMARY OF INVENTION

In accordance with an embodiment of the present invention, a method to project staffing needs may include predetermining an optimal prediction method for predicting staffing needs from a plurality of prediction methods based on at least one of a center, a target day in a forecasting horizon and a time interval using historical data. The method may also include predicting future staffing needs for at least one of a selected center, a selected target day and a selected time interval by using the predetermined optimal prediction method for the at least one of the selected center, selected target day and selected time interval.

In accordance with another embodiment of the present invention, the method may also include calculating an expected number of staff members to be present for the at least one selected center, target day and time interval by subtracting a no-show prediction from a prescheduled number of staff members.

In accordance with another embodiment of the present invention, a system to project staffing needs may include a data structure to predetermine an optimal prediction method for predicting staffing needs from a plurality of prediction methods based on at least one of a center, a target day in a forecasting horizon and a time interval using historical data. The system may also include a data structure to predict future staffing needs for at least one of a selected center, a selected target day and a selected time interval by using the predetermined optimal prediction method for the at least one of the selected center, selected target day and selected time interval.

In accordance with another embodiment of the present invention, a computer program product to project staffing needs may include a computer readable medium having computer readable program code embodied therein. The computer readable medium may include computer readable program code configured to predetermine an optimal prediction method for predicting staffing needs from a plurality of prediction methods based on at least one of a center, a target day in a forecasting horizon and a time interval using historical data. The computer readable medium may also include computer readable program code configured to predict future staffing needs for at least one of a selected center, a selected target day and a selected time interval by using the predetermined optimal prediction method for the at least one of the selected center, selected target day and selected time interval.

### BRIEF DESCRIPTION OF THE SEVERAL VIEWS OF THE DRAWINGS

FIGS. 1A-1E (collectively FIG. 1) are a flow chart of an example of a method to project staffing needs and support staffing decisions in accordance with an embodiment of the present invention.

FIG. 2 is an illustration of a screen shot, web page or the like including an example of predicted (target) staffing needs compared to scheduled staffing corrected for no-shows in accordance with an embodiment of the present invention.

FIG. 3 is an illustration of a graphical user interface (GUI), screen shot or the like including an example of a proactive protocol in accordance with an embodiment of the present invention.

FIG. 4 is an illustration of a screen shot, web page or the like including an example of a graph comparing predicted staffing needs to actual staffing needs to determine whether to re-evaluate the accuracy of the prediction methods in accordance with an embodiment of the present invention.

FIGS. 5A-5E (collectively FIG. 5) are a flow chart of an example of a method to determine an optimal prediction method for predicting staff by skill in accordance with an embodiment of the present invention.

FIGS. 6A-6C (collectively FIG. 6) are a flow chart of an example of a method to determine an optimum prediction method for predicting the probability of a prescheduled staff member not showing for work in accordance with an embodiment of the present invention.

FIG. 7 is a flow chart of an example of a method to determine optimum proactive protocols in accordance with an embodiment of the present invention.

FIG. 8 is a block diagram of an exemplary system to project staffing needs in accordance with an embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects which all may generally be referred to herein as a “circuit,” “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with an instruction execution system, apparatus, or device.

Computer program code for carrying out operations of the present invention may be written in an object oriented programming language such as Java7, Smalltalk or C++ or the like. However, the computer program code for carrying out operations of the present invention may also be written in conventional procedural programming languages, such as the “C” programming language or similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

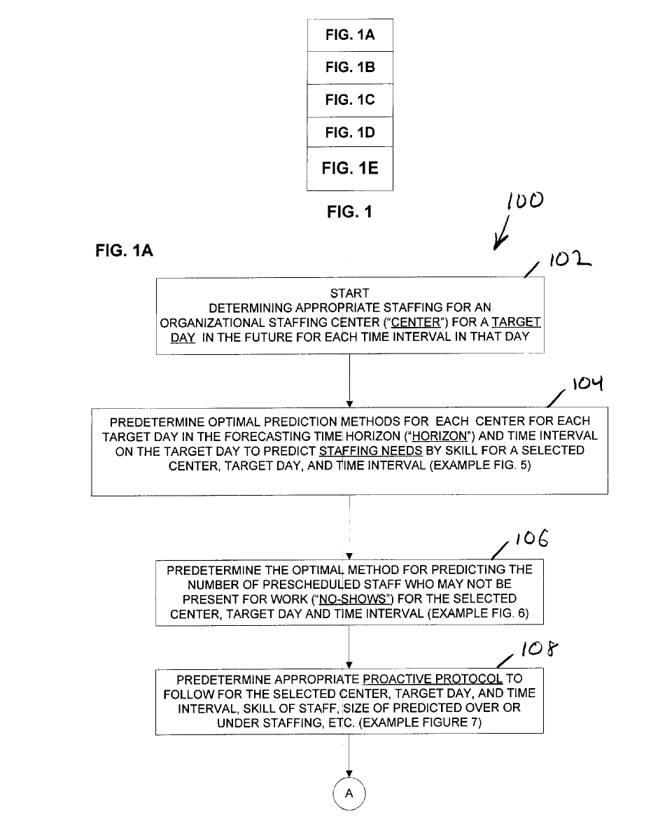

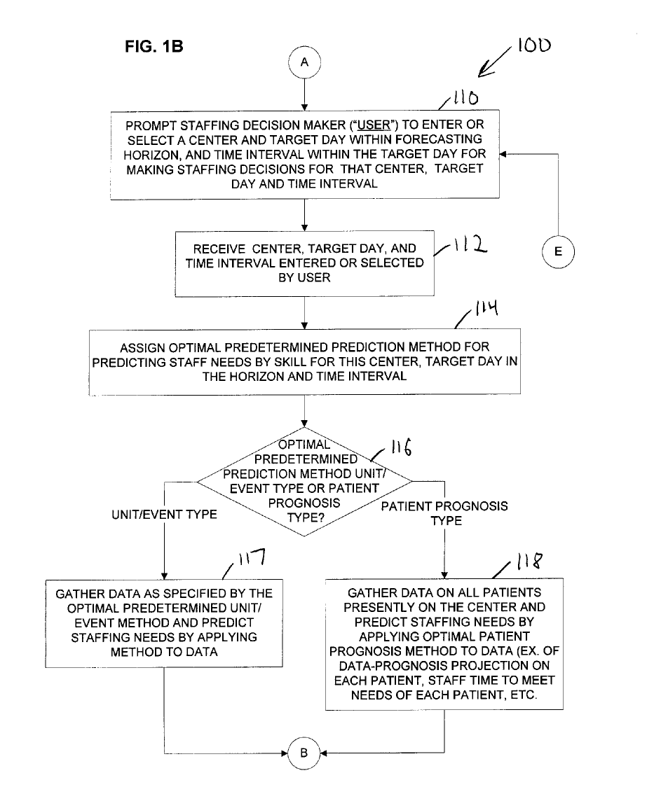

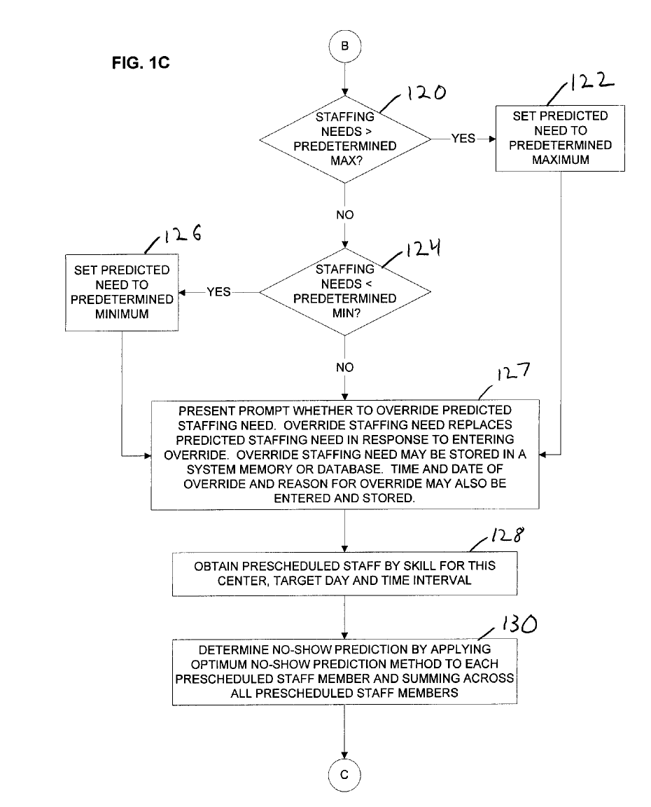

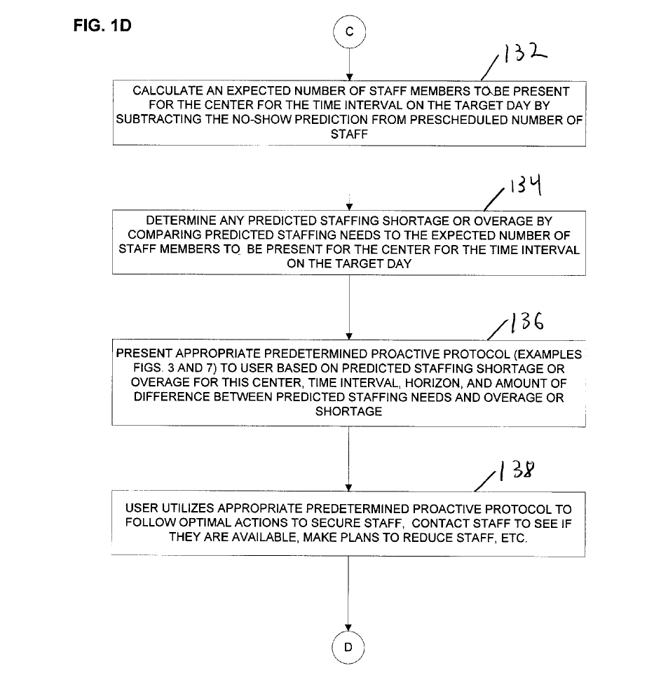

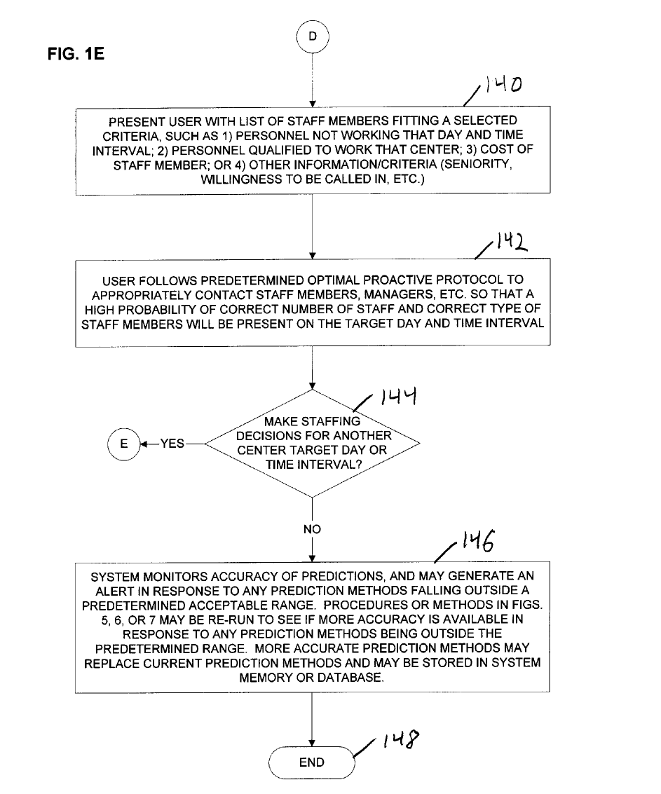

FIGS. 1A-1E (collectively FIG. 1) are a flow chart of an example of a method 100 to project staffing needs in accordance with an embodiment of the present invention. In block 102, the method 100 for determining appropriate staffing for an organizational staffing unit, center or the like may start. The appropriate staffing for the center may be for any selected time interval in a target day in the future. An organizational staffing unit, center or the like may be part of an organization that uses a set of staff that may need to be present to meet the goal or goals of the particular center. Examples of a center may include, but are not necessarily limited to, nursing units, groups of nursing units, teams within a nursing unit, teams that serve multiple nursing units, a radiology department, an emergency room, a dietary department, transportation services within a healthcare facility or group of facilities, a pharmacy, a clinic or similar units or centers. Center may be considered a “cost center,” unit or department within an organization but may be any organizational unit or sub-organizational unit that may require a certain quantity of staff members based on load to meet assigned goals, level of service, production or the like.

The present invention may be described as being used to project staffing needs and deploy staff to optimally meet those needs in a healthcare facility, such as a hospital, group of hospitals, clinic, group of clinics, or the like. However, the present invention may be used in any organization, environment or industry where predicting staffing needs and making staffing decisions may be used, such as hotels, restaurants, call-centers, manufacturing facilities, service facilities or the like.

A target day, as used herein, may be a day in the future for which staffing decisions may be required. A time interval may be any interval of time within a target day for which staffing decisions may be made. For staffing purposes, a time interval may cross midnight or the previous midnight of the target day. A target day may include two 12-hour time intervals, three 8-hour time intervals, one 24-hour time interval, 24 one hour time intervals, four 2-hour intervals plus four 1-hour intervals plus one 12-hour interval, or any combination of such beginning at any hour, half hour, quarter hour, etc.

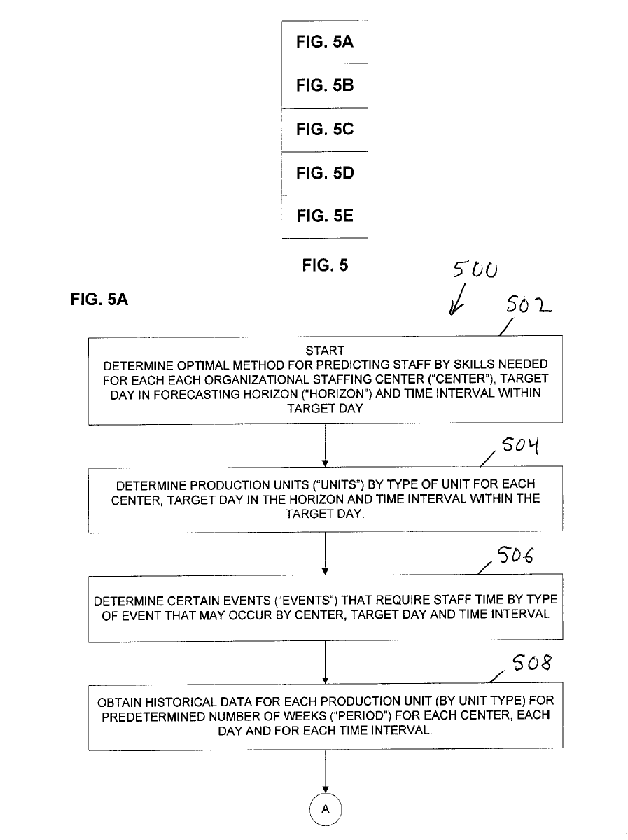

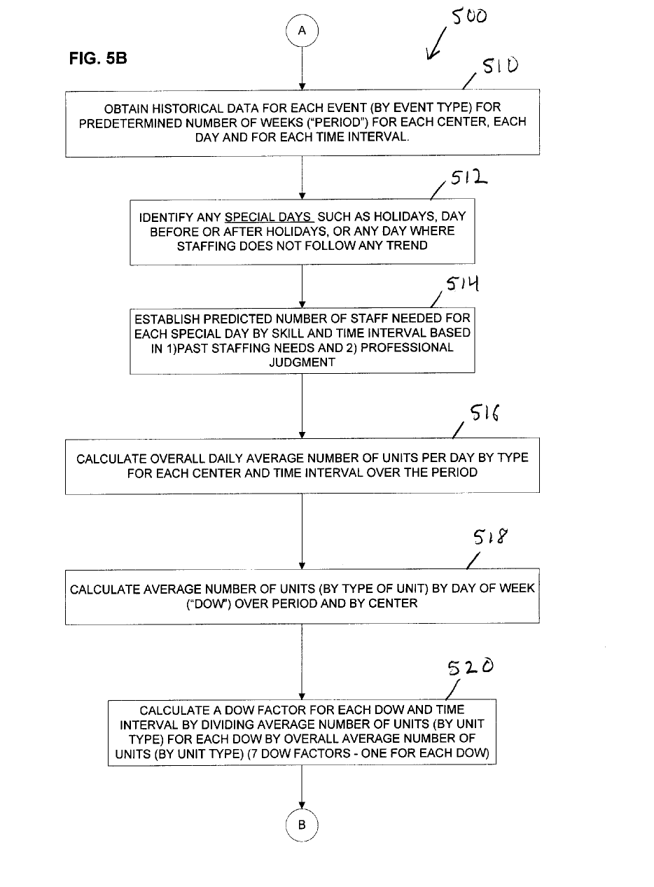

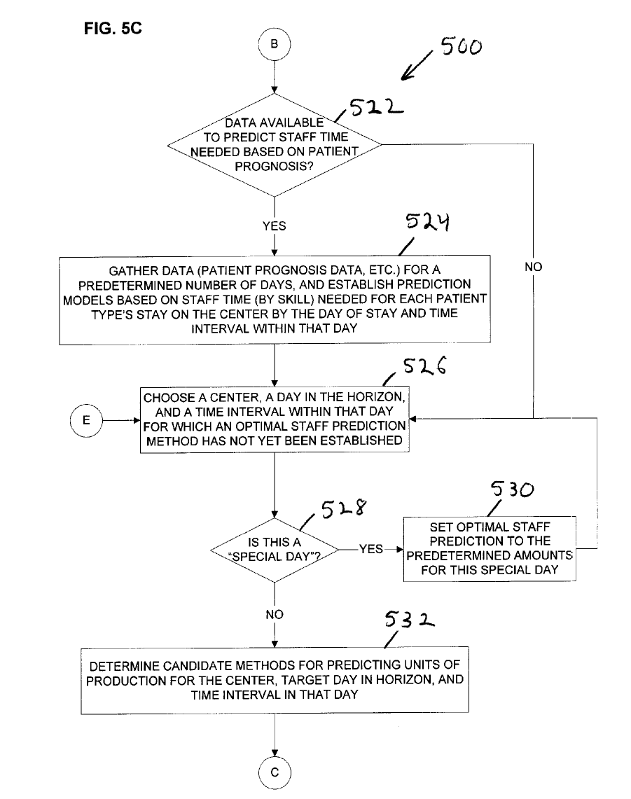

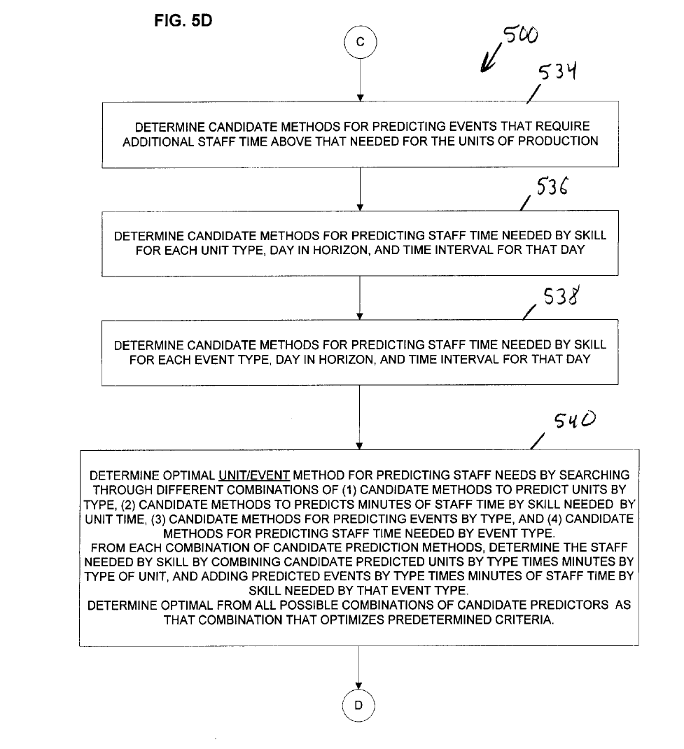

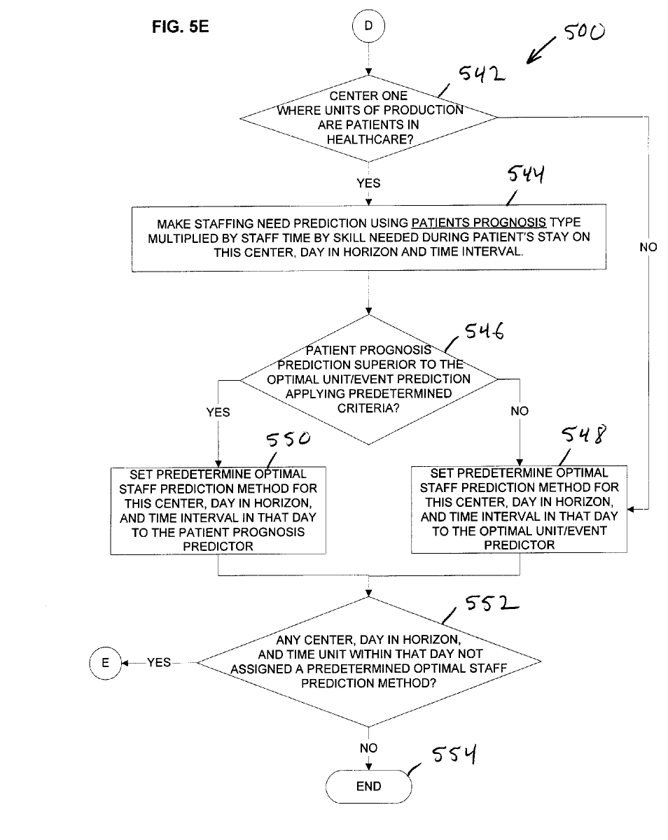

In block 104, optimal prediction methods for each center, for each target day in a forecasting horizon (“horizon”) and time interval on the target day may be predetermined to predict staffing needs by skill for a selected center, target day and time interval. An exemplary method to predetermine an optimal prediction method or methods for predicting staff will be described in more detail with reference to FIG. 5 below. The forecasting horizon may be any defined period of time, such a single day to several days to several weeks. Predicting staffing needs for a future day may become less accurate the longer the forecast horizon in some environments or industries. For example, in some healthcare environments or like settings, a forecasting horizon of more than about fourteen (14) days or two weeks may not be that reliable. In more predictable environments or industries longer forecasting horizons may have some practical purposes.

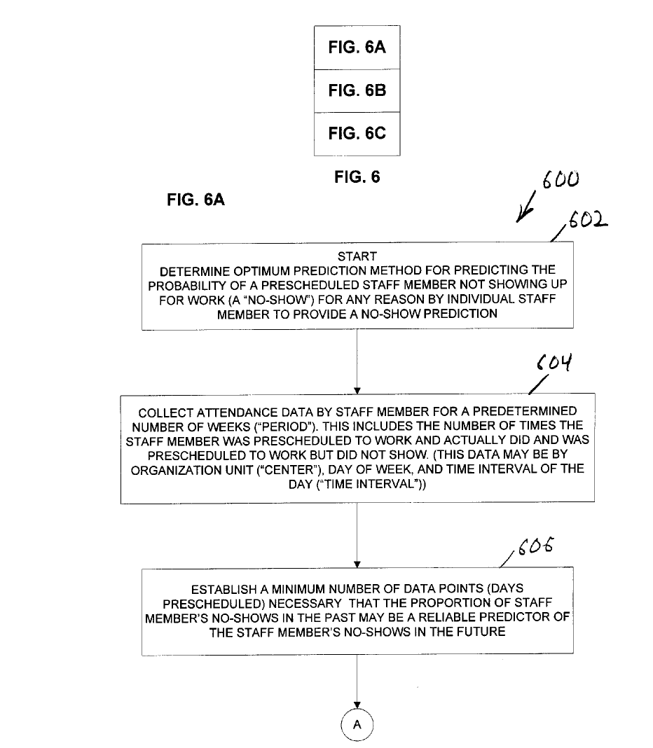

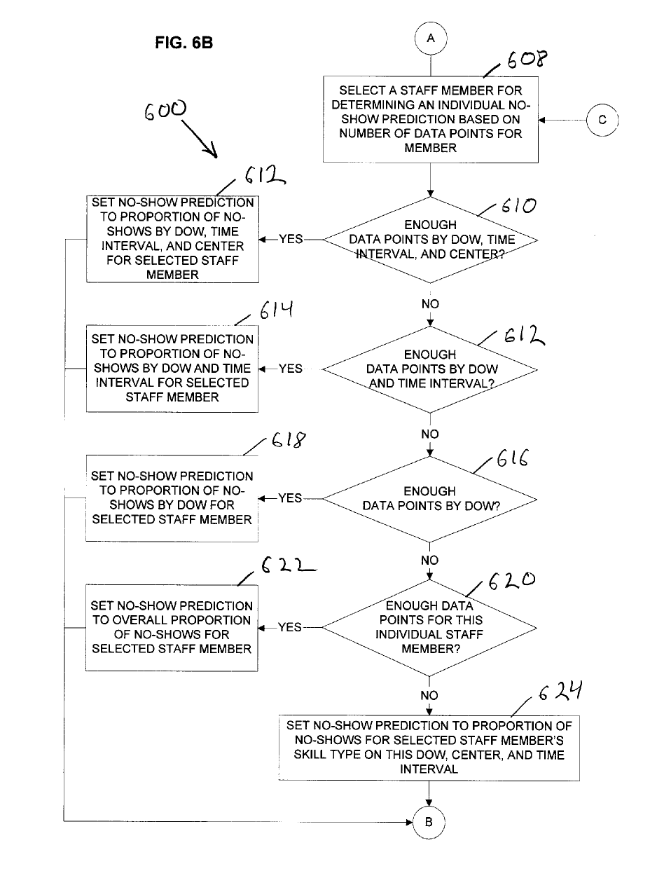

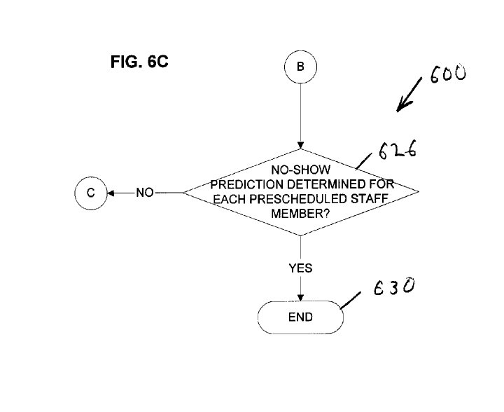

In block 106, an optimal method for predicting the number of prescheduled staff who may not be present for work (“no-shows”) for the selected center, target day and time interval may be predetermined. An example of determining a prediction method for predicting the probability of a prescheduled staff member not showing up for work for any reason by individual staff member to provide a no-show prediction will be described in more detail with reference to FIG. 6 below.

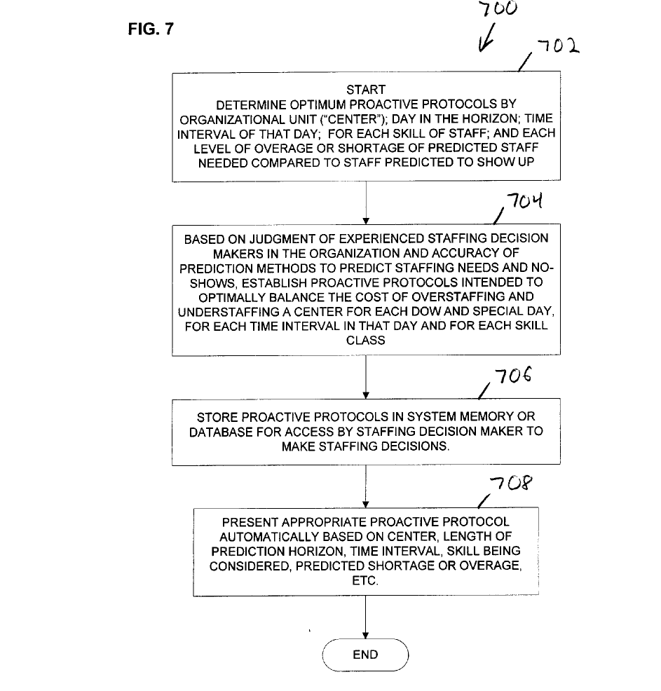

In block 108, an appropriate proactive protocol for a staffing decision maker or user to follow for the selected center, target day, time interval, skill of staff and size of predicted over or under staffing may be predetermined. An example of determining optimum proactive protocols will be discussed with reference to FIG. 7.

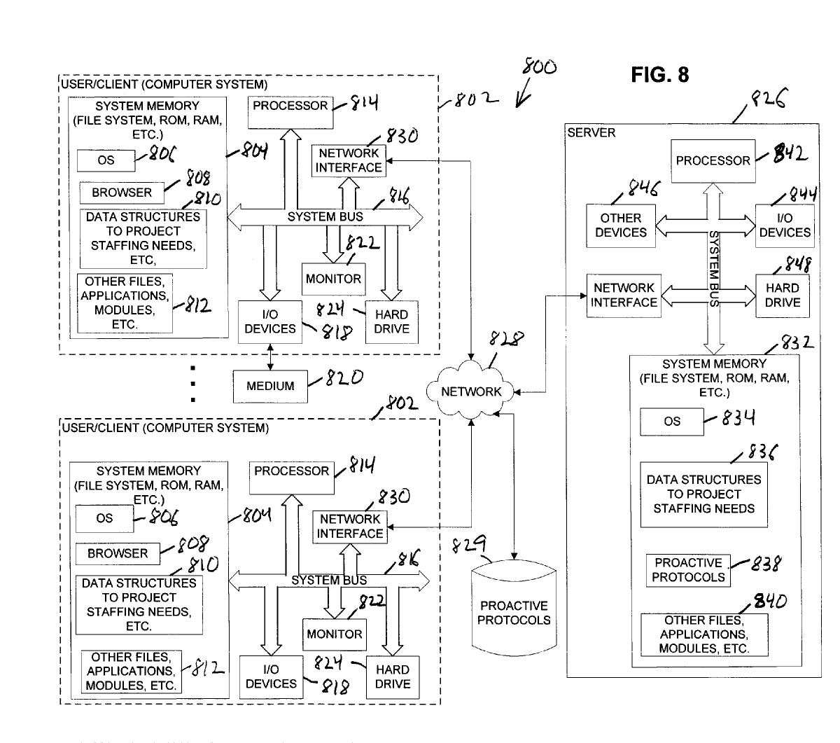

In block 110, a staffing decision maker or user may be prompted to enter or select a center and target day within a forecasting time horizon and time interval within the target day for making staffing decisions for that center, target day and time interval. The user may be prompted by a graphical user interface (GUI) or the like that may be presented on a computer monitor by a web browser of a client computer system, such as the computer system described with reference to FIG. 8. The user may then enter the center, time interval and target or select from preformed drop-down lists.

In block 112, the center, target day and time interval entered or selected by the user may be received by the system or method 100. In block 114, an optimal predetermined prediction method may be assigned from a plurality of prediction methods for predicting staff needs by skill based on the center, target day and time interval. Such methods may be formulated, evaluated, and the optimal method for this center, day in forecast, and time interval in that day determined as described in FIG. 5.

In decision block 116, a determination may be made as to whether the optimal predetermined prediction method for the center, target day and time interval is a Unit/Event type prediction method or a Patient Prognosis type prediction method. An example of whether a Unit/Event type prediction method or a Patient Prognosis type prediction method may be used and predicting staffing needs using each type method are discussed in more detail with respect to method 500 of FIG. 5. If the optimal method is determined to be a Unit/Event type in block 116, the method 100 may advance to block 117. In block 117, data may be gathered as specified by the optimal Unit/Event prediction method and the staffing needs prediction may be made with that data and method. If in block 116 the determination is that the optimal method is the Patient Prognosis type, the method 100 may advance to block 118. In block 118, data may be gathered on all patients presently on the center. Examples of the data that may be gathered may include a prognosis projection made on each patient, staff time needed to meet the needs of each patient at each stage of the patient's projected prognosis being applied and similar data. Staff time needed may then be predicted using the Patient Prognosis type prediction method as described in more detail with respect to method 500 of FIG. 5.

In decision block 120, a determination may be made whether the staffing needs calculated in block 116 exceed a predetermined maximum. If the predetermined maximum is exceeded in block 120, the method 100 may advance to block 122. In block 122, the predicted staffing need may be set to the predetermined maximum in response to the predicted staffing needs exceeding the predetermined maximum in block 120. If the staffing needs do not exceed the predetermined maximum in block 120, a determination may be made in block 124 whether the predicted staffing needs are less than a predetermined minimum. The predicted staffing needs may be set to the predetermined minimum in block 126 in response to the staffing needs being less than the predetermined minimum in block 124. If the predicted staffing needs are not less than the predetermined minimum in block 124, the method 100 may advance to block 127.

In block 127, the user may be prompted whether there is a desire to override the predicted staffing need. This override of the staffing need may be the result of professional judgment related to the particular environment, center, organization, target day, time interval or the like for which staffing is being predicted. The override staffing need may replace the predicted staffing need in response to a user or another entering an override. The override staffing need may be stored in a system memory or database. Information or data related to the override staffing need, such as time and date of the override along with a reason for the override or similar information, may also be stored in association with the override. The staffing needs designated by the override then, in effect, become the predicted staffing need.

In block 128, prescheduled staff by skill may be obtained for the selected center, target day and time interval. In block 130, a no-show prediction may be determined by applying the optimum no-show prediction method determined in block 106 to each prescheduled staff member and summing the individual predictions across all prescheduled staff members. In block 132, an expected number of staff members to be present for the center for the time interval on the target day may be calculated by subtracting a no-show prediction from the prescheduled number of staff. Determination of the no-show prediction will be discussed in more detail with reference to method 600 in FIG. 6.

In block 134, any predicted staffing shortage or overage may be determined by comparing predicted staffing needs to an expected (or prescheduled) number of staff members to be present for the center for the time interval on the target day. The expected or prescheduled number of staffing members may be corrected for predicted no-shows.

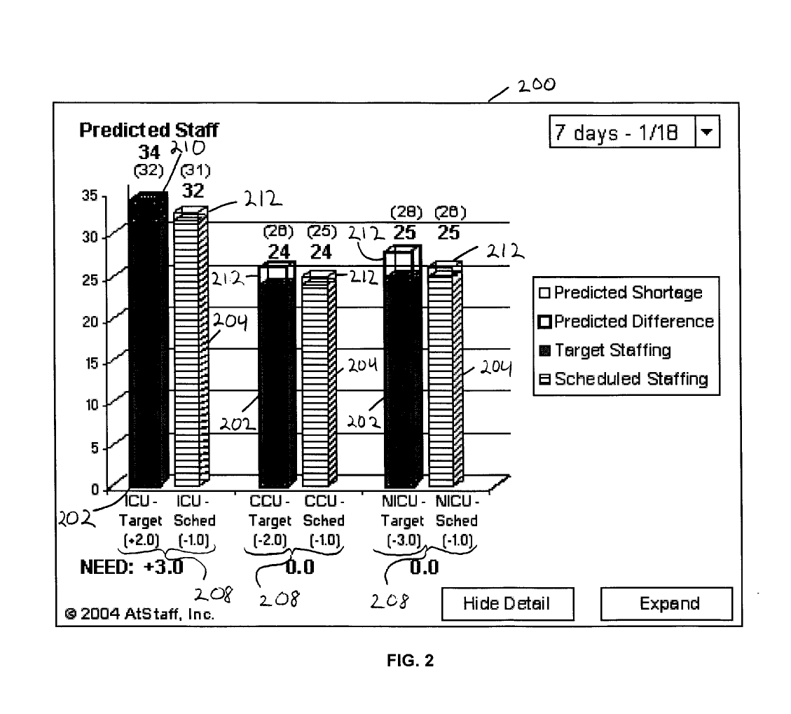

FIG. 2 is an illustration of a screen shot 200, web page or the like including an example of predicted staffing needs (“target” in FIG. 2) 202 compared to prescheduled staffing needs (204) corrected for no-shows (“Sched” in FIG. 2) in accordance with an embodiment of the present invention. The screen shot illustrates examples of possible grouping of similar centers (“ICU”, “CCU”, AND “NICU” in FIG. 2). Also illustrated in screen shot 200 are a predicted difference or overage in staffing needs and predicted shortages 208.

Returning to FIG. 1, in block 1 36, an appropriate predetermined proactive protocol may be automatically presented to the user by the method 100 or system based on whether there is a predicted staffing shortage or overage for the center of interest, time interval, horizon and the predicted size of the overage or shortage. The particular proactive protocol presented may also be dependent upon the center, target day, length of horizon, and time interval for which staffing is being predicted and prescheduled as well as other criteria such as how close to the Maximum or Minimum predicted staffing is, what qualifications the prescheduled staff have, etc.

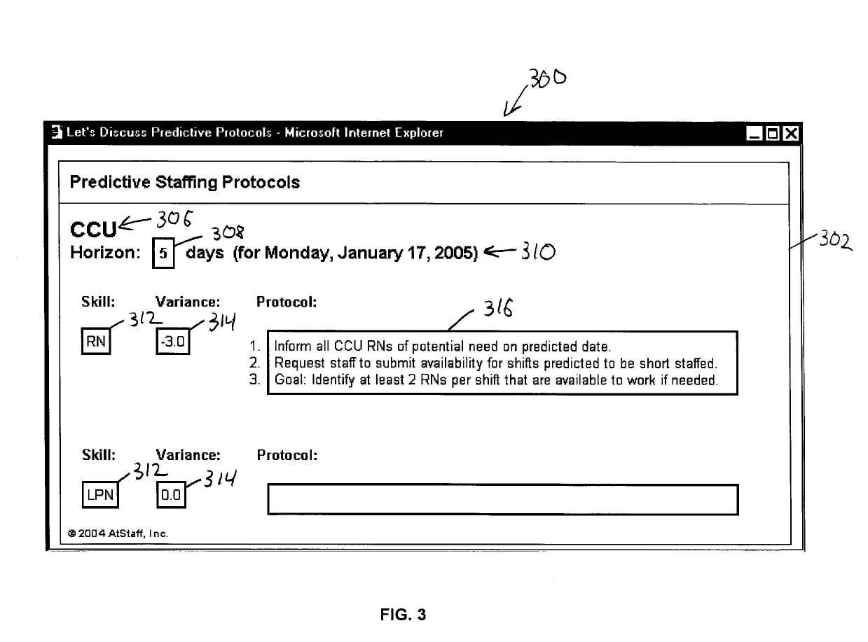

Referring also to FIG. 3, FIG. 3 is an illustration of a graphical user interface 300 (GUI), screen shot or the like including an example of a proactive protocol 302 in accordance with an embodiment of the present invention. The proactive protocol GUI 300 may indicate the center 306 for which staffing needs are being predicted, the horizon 308 and the target day 310. The proactive protocol GUI 300 may also indicate skill types 312 and a variance 314 in staffing needs associated with each skill type 312. Also presented will be the actual proactive protocol 316 to be followed by the user. There may be a different proactive protocol associated with each combination of center, horizon length, time interval, skill type, and the size of the predicted variance by skill type.

Returning to FIG. 1, in block 1 38, the user may utilize the appropriate predetermined proactive protocol to follow the optimal actions, such as actions or protocols 316 in FIG. 3, to secure staff, contact staff to determine if they are available, make plans to reduce staff if there is an overage, or other actions depending upon the predetermined proactive protocol.

In block 140, a list of staff members fitting selected criteria may be provided or presented to the user. The selected criteria may include personnel not working that day and time interval; personnel qualified to work the selected center; cost or compensation of such staff members; other information or criteria, such as seniority, willingness to be called in, recent history of being called in, overtime, or similar information or criteria.

In block 142, the user may follow the predetermined proactive protocol to appropriately contact staff members, managers and the like so that a probability of a correct or cost effective number of staff members and correct type of staff members will be present on the target day and time interval.

In block 144, a determination may be made whether another staffing decision for another center, target day or time interval may need to be made. If so, the method 100 may return to block 110 in FIG. 1B and the method 100 may proceed as previously described. If another staffing decision does not need to be made or the user selects no to a prompt or dialogue box to make another staffing decision in block 144, the method 100 may advance to block 146. In block 146, the system may monitor the accuracy of the predictions by tracking the predicted staffing needs to the actual staffing needs on the target days. An alert may be generated in response to any predictors or optimal prediction methods falling outside of a predetermined acceptable range. If any optimal prediction method falls outside of preset limits, the respective prediction method in FIGS. 5, 6, or 7 may be re-run to determine a more accurate or new optimal method. Alternatively, each of the methods for determining an optimal prediction method may be periodically run or evaluated to determine if there is a more accurate method of predicting each of the staffing criteria. A more accurate prediction method may replace the current method and be stored in the system memory or database. The method 100 may end at termination 148.

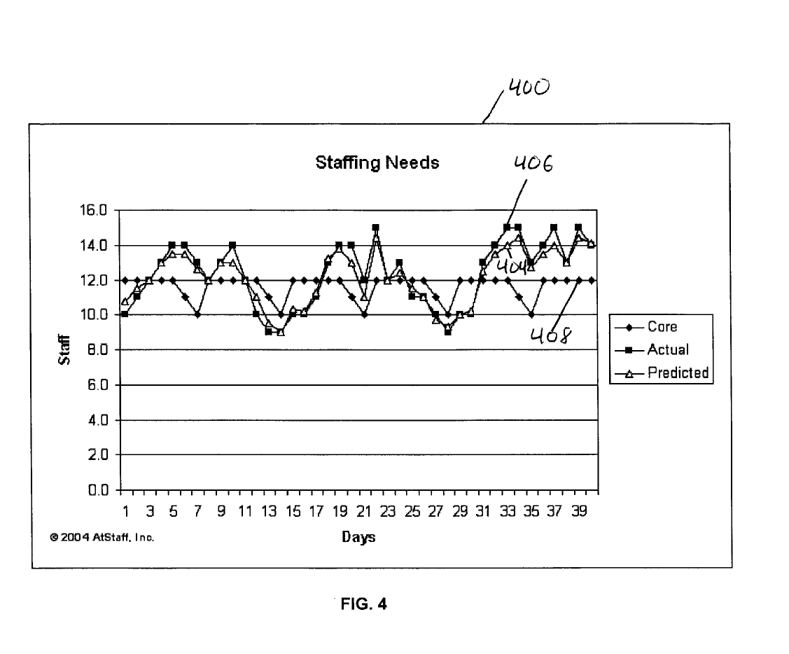

FIG. 4 is an illustration of a screen shot 400, web page or the like including an example of a graph representation comparing a predicted staffing needs graph 404 to an actual staffing needs graph 406 to determine whether to re-run or re-evaluate an accuracy of the prediction methods in accordance with an embodiment of the present invention. If the predicted staffing needs 404 substantially coincide with the actual staffing needs, re-evaluating the prediction methods may not be warranted. A core staffing needs graph 408 may also be presented for comparison with the predicted staffing needs graph 404 and actual staffing needs graph 406.

FIGS. 5A-5E (collectively FIG. 5) are a flow chart of an example of a method 500 to determine an optimal prediction method for predicting staff by skill in accordance with an embodiment of the present invention. The method 500 may be used in block 104 of FIG. 1 to predict a quantity of staff by skill for a center, target day and time interval within a target day. In block 502, the method 500 to determine an optimal prediction method for predicting staff by skill needed for each organizational staffing center, target day in a forecasting horizon, and time interval within a target day may start.

In block 504, production units (“units”) by type of unit may be determined for each center, such production units requiring a certain amount of staff time by skill and time interval. Other blocks within method 500 illustrate an example of determining an optimal prediction method for the number of units that will require staff time. Production units by type of unit may be discreet units that a center produces, serves, services, takes care of, is responsible for or the like over a time interval on the target day. In a hospital, for example, production units may include patients by type (level 1, level 2, level 3, etc.—each type requiring a different amount of staff time by skill), radiology procedures by type (each type requiring a different number of minutes of staff time, by staff skill), meals, rooms to be cleaned, prescriptions to be filled, operating procedures to be performed and the like.

In block 506, certain events (“events”) that require staff time may be determined. Examples of events may include change in patient condition, maintenance of equipment, orientation of new staff, other on-site training, visits by accrediting teams, and other events.

In block 508, historical data for each production unit, by unit type, may be obtained or collected for each center. The historical data may be obtained for a predetermined number of weeks or predetermined time period for each center and for each day and time interval. The optimal prediction method determined from method 500 may be more accurate or reliable the longer the time period or predetermined number of weeks and therefore the larger the sampling of historical data. Similarly, in block 510, historical data for each event, by event type, may be obtained or collected.

In block 512, any special days by center may be identified. Special days may be holidays or a day before or after a holiday or any day where staffing may not follow any trend based on overall averages or staffing on preceding days. In block 514, a predicted number of staff needed for each special day by skill and time interval may be established. The predicted number of staff needed may be established based on past staffing needs on the special day, professional judgment or other criteria.

In block 516, an overall daily average number of production units per day by unit type may be calculated for each center, day and time interval. The overall daily average may be calculated by summing the number of units by type each day for each center and time interval and then dividing by the total number days in the period. Any special days in the sample data may be omitted in order to not skew the averages.

In block 518, an average number of units, by unit type, by day of the week (“DOW”) and by center may be calculated by summing the number of units for each day of the week over the period and dividing by the total number of units for that DOW in the period. Any special days may be omitted in order to not skew the averages.

In block 520, a DOW factor may be calculated for each center, DOW and time interval by dividing the average number of units, by unit type, for each DOW by the overall average number of units, by unit type. There may be seven (7) DOW factors, one for the day of the week.

In block 522, a determination may be made whether there is data available to predict staffing needs using a method other than or in addition to the number of production units (by type) and events (by type) method (the “Unit/Event” class or type of prediction methods). In accordance with one embodiment of the present invention for use in healthcare, a determination may be made in block 522 if the units of production are patients and if data is available to predict, by patient type or diagnosis, staff time needed by skill based on a patient's prognosis of this type of patient (the “Patient Prognosis” type of prediction method) for future days and time intervals within those days of the patient's stay on the center. If data is not available in block 522 to predict staffing needs based on patient prognosis, the method may advance to block 526. If data is available in block 522 to predict staffing needs on patient prognosis, the method may advance to block 524. In block 524, data, such as patient prognosis data or like in a healthcare embodiment of the present invention, may be gathered or obtained for a predetermined number of days. The Patient Prognosis prediction method may involve assessment of each patient as of the time the prediction is to be made, and prediction of the stages of each patient's progress or lack thereof, along with the amount of staff time required to provide quality care for the patient at each stage of his/her stay going forward. By adding up staff time across all patients, based on what stage they are in on the target day and time interval within that day, a prediction of staff time needed for the center on that day and time interval may be made. This then may become a candidate predictor of staff need, which may be compared with the Unit/Event prediction in block 546.

In block 526, a center, day in the horizon, and time interval within that day may be chosen for which an optimal staffing need prediction method may not yet have been established. In block 528, a determination may be made whether the day is a special day. If the day is a special day, the method 500 may advance to block 530. In block 530, the optimal staff prediction may be set to the predetermined amounts for this special day. The predetermined amounts for each special day may be determined as previously described with reference to block 512.

If the day is not a special day in block 528, the method 500 may advance to block 532. In block 532, candidate methods for predicting units of production for the center, target day in the horizon and time interval in the target day may be determined. Examples of candidates for predicting units (by center, day in horizon, and time interval) may include:
Overall Average number of units by center and time interval
Overall Average by center and time interval corrected by day of week
Short term trend analyses based on the last N days characterized by
   Pₖ=((SUM_{n=1,N}Wₙ*Uₙ/DOW_{dn})/SUM_{n=1,N}Wₙ)*DOW_{d}
   Where
Pₖ is one of K candidate predictions
N is the length of the trend (e.g. last 12 days; N=12)
U_{n, n=1,N} is the number of units that occurred on past day n
W_{n, n=1, N} is a weight applied to Uₙ
DOW_{dn} is the day of week correction factor, similar to that previously described with respect to block 520 for the nth day of the trend which falls on DOW d
DOW_{d} is the DOW correction factor of Para 50 for this prediction DOW d

Thus for example for a past trend length N=7, which includes the last 7 days, 7 weights W_{n=1,7} are picked arbitrarily to weight either the last set of days, or the first set of days, or some other set of days higher or lower than some other set. (Typically, the last set of days would have higher weights than the first set of days). The number of units Un on past day n (n between 1 and 7) is first corrected (“normalized”) for its day of week by dividing by DOW_{dn}, then multiplied by its weight Wₙ, and the results summed for the N days. The summed result is then divided by the sum of the N weights and finally re-corrected for the day of the week of the prediction (DOW_{d}) to produce a candidate prediction Pₖ representing the size of N and the set of weights W_{n=1,N}. Thus there are an infinite number of candidate predictors Pₖ of this “trend” type. The “trend” type unit predictors Pₖ may be combined with the overall average types of unit predictors to form additional candidate predictors. For example, a candidate unit predictor may be 50% of the Overall Average corrected by day of week, and 50% Pₖ, where Pₖ is derived from a particular set of N weights. In block 534, candidate methods for predicting events that may require additional staff time above that needed for the units of production may be determined. Such candidates may be the number of events occurring from the past data corrected by day of week, or season of the year.

In block 536, candidate methods for predicting staff time needed by skill for each unit type, day in the horizon and time interval for that day may be determined. Such candidates may include average amount of time needed by skill for each unit type over the past data corrected by day of week, or season of the year.

In block 538, candidate methods for predicting staff time needed by skill for each event type, day in the horizon and time interval for that day may be determined. Such candidates may include average amount of time needed by skill for each event type over the past data corrected by day of week, or season of the year.

In block 540, an optimal “Unit/Event” method for predicting staff needs may be determined by searching through and evaluating different combinations of 1) candidate methods to predict units by type, 2) candidate methods to predict minutes of staff time by skill needed by unit time, 3) candidate methods for predicting events by type and 4) candidate methods for predicting staff time needed by event by type. Thus a candidate “Unit/Event” method will consist of choosing one “sub-candidate” from each of the above four classes. The optimal Unit/Event method may be the one that scores highest on a score defined by weighing ranges of error that this method produced on past data from the center. Such a score scheme might be XI times the proportion of times this method produced a prediction that was within 0.5 staff members, X2 times the proportion of times it produced a prediction with an error that was between 0.5 and 1.5 staff members, X3 times the proportion of times it produces a prediction with an error between 1.5 and 2.5 staff members, etc. Weights X1, X2, . . . may be picked to weight the relative costs or undesirability of having errors of that size. The selection of the Optimal Unit/Event method of prediction of staff may be found by a “Branch and Bound” search procedure, where the search starts with an intuitively promising candidate, evaluating it, and then one by one switching out sub-candidate methods to see if a path of such switching out produces higher scores. Branch and Bound search procedures are known Operations Research techniques and are described in Operations Research: Deterministic Optimization Models by Katta G Murty, Prentice Hall 1995, or any Operations Research text.

Once scores no longer increase, another “path” of switching out sub-candidates is tried, to see if a higher score can be reached. By trying hundreds of different “paths” (thousands of candidates), the optimal one is the one with the highest score. A computer program to perform the search may be used to look at thousands of such candidates, and select the optimal one.

In block 542, a determination may be made whether the center is one where units of production are patients in a healthcare facility. If the center is not one where production units are patients, the method 500 may advance to block 548. Block 548 will be discussed in more detail below. If the center is one where the units of production are patients in a healthcare facility or environment, the method 500 may advance to block 544. In block 544, a staffing need prediction may be made using a patient's prognosis type multiplied by staff time by skill needed during the patient's stay on this center, day in the horizon and time interval as previously described with respect to block 522.

In block 546, a determination may be made whether the Patient's Prognosis prediction is superior to the optimal Unit/Event prediction method by applying the same predetermined criteria to the Patient Prognosis prediction described with respect to block 540, and comparing the score of the best Unit/Event prediction to the score of the Patient Prognosis prediction. If Patient's Prognosis is not superior to the optimal Unit/Event prediction, the method 500 may advance to block 548. In block 548, the predetermined optimal staff prediction method for this center, day in horizon and time interval in that day may be set to the optimal Unit/Event predictor or prediction method.

If the Patient's Prognosis in block 546 is superior to the optimal Unit/Event prediction method, the method 500 may advance to block 550. In block 550, the predetermined optimal staff prediction method for this center, day in the horizon and time interval in that day may be set to the Patient Prognosis predictor method.

In block 552, a determination may be made whether any center, day in the horizon, and time unit within that day has not been assigned a predetermined optimal staff prediction method. If any center, day in horizon and time unit within that day has not been assigned a predetermined optimal staff prediction method, the method 500 may return to block 526 and the method 500 may proceed as previously discussed. If all centers, days in the horizon and time units have been assigned a predetermined optimal staff prediction method, the method 500 may end at termination 554.

FIGS. 6A-6C (collectively FIG. 6) are a flow chart of an example of a method 600 to determine a prediction method for predicting the probability of a prescheduled staff member not showing up for work in accordance with an embodiment of the present invention. In block 602, the method 600 may start. The optimal method determined may predict the probability of a no-show by individual staff member to provide the no-show prediction for use in block 130 of method 100 (FIG. 1).

In block 604, attendance data by staff member may be collected or obtained for a predetermined number of weeks or predetermined time period. The data may include the number of times the staff member was prescheduled to work and actually did work and the number of times the staff member was prescheduled to work but did not show (was a no-show). The attendance data may be collected by staff member, organization center, day of the week, and time interval of the day.

In block 606, a minimum number of data points or prescheduled days each staff member was prescheduled may be established such that there is statistical reliability that the proportion of a staff member's no-shows in the past may be a reliable predictor of the staff member's no-shows in the future. This minimum sample size may be set to the sample size that statistically produces a confidence statement such as “XX percent of the time this proportion will be within YY percentage points”, where XX and YY are established by the institution as acceptable. This minimum sample size may determine whether, for a particular staff member, the predictor will be by DOW, by time interval within a day, and by center (see blocks 610-624 below), or by just DOW or time interval, or by just DOW, or the overall proportion of no-shows for this staff member, or by similar staff members.

In block 608, from all staff members on all centers, a particular staff member may be selected for determining his/her individual no-show prediction based on the number of data points for the member. In block 610, a determination may be made whether there are enough data points by day of the week (DOW), time interval and center to provide a statistically reliable prediction of whether the staff member may be a no-show on the target day by center, DOW, and time interval. If a determination is made in block 610 that there are enough data points, the method 600 may advance to block 612. In block 612, the no-show prediction for the selected staff member in block 608 may be set to the proportion of no-shows by DOW, time interval, and center for the selected staff member. The proportion of no-shows (“proportion of no-shows) for this staff member may be calculated by dividing the number of times the selected staff member did not show up by the number of times he/she was prescheduled to show up (by center, DOW, and time interval).

If a determination is made in block 610 that there are not enough data points to provide a statistically reliable estimate by DOW, time interval and center, the method may advance to block 612. In block 612, a determination may be made if there are enough data points by DOW and time interval to provide a statistically reliable prediction of whether the selected staff member may be a no-show by DOW and time interval. The method 600 may advance to block 614 in response to there being enough data points in block 612. In block 614, the no-show prediction for the selected staff member may be set to the proportion of no-shows by DOW and time interval for the selected staff member.

If there are not enough data points in block 612, the method 600 may advance to block 616. In block 616, a determination may be made whether there are enough data points to provide a statistically reliable prediction of whether the selected staff member will be a no-show by DOW. If there are enough data points in block 616, the no-show prediction for the selected staff member may be set to the proportion of no-shows by DOW for the selected staff in block 618. If there are not enough data points in block 616, the method 600 may advance to block 620. In block 620, a determination may be made if there are enough data points for the selected staff member to support a statistically reliable prediction for this staff member overall. If there are enough data points, the no-show prediction for the selected staff member may be set to the overall proportion of no-shows for the selected staff in block 622. If there are not enough data points for this individual staff member in block 620, the no-show prediction may be set to the proportion of no-shows for the selected staff member's skill type on this DOW, center and time interval in block 624.

In block 626, a determination may be made whether a no-show prediction has been determined for each staff member for all centers. If a no-show prediction has not been determined for each staff member, the method 600 may return to block 608 and another staff member may be selected. The method 600 may then proceed as previously described. If a no-show prediction has been determined for each staff member in block 626, the method 600 may advance to block 630 and end.

FIG. 7 is a flow chart of an example of a method 700 to determine optimum proactive protocols in accordance with an embodiment of the present invention. In block 702, the method 700 may start. The method 700 may determine optimum protocols by organizational center, the length of the forecast horizon (number of days in the future) the time interval within the day, the skill of staff being considered, and the size of the difference between how many of that skill is predicted to be needed and how many of that skill is being predicted to show up.

In block 704, the proactive protocols may be based on judgment of experienced staffing decision makers in the organization. The actions specified by these decision makers may be based on the accuracy of the prediction methods to predict staffing needs and no-shows, the cost of calling in a staff member when they may not be needed, the cost of waiting to call in a staff member who turns out to be needed, the cost of not being able to find a staff member to call in, etc. The proactive protocols established are intended to optimally balance the cost of overstaffing and understaffing a center for each day and time interval in that day and for each skill class in the decision making (forecasting) horizon, and the benefit of giving staff members as much notice as possible that they will be needed or not needed.

In block 706, the proactive protocols may be stored in a system memory or database for access by staffing decision makers to make staffing decision. In block 708, the appropriate proactive protocol may be presented automatically to a user based on the center, the length of horizon of the target day (how many days in the future from the day the prediction is being made), the time interval of the day, the skill being considered, and the predicted shortage or overage of staff of that skill in block 1 36 of method 100. The method 700 may end at termination 710.

FIG. 8 is a block diagram of an exemplary system 800 to project staffing needs in accordance with an embodiment of the present invention. The methods 100, 500, 600 and 700 of FIGS. 1, 5, 6 and 7, respectively, may be embodied in and performed by the system 800. The system 800 and the method 100 may generate and present the images or screen shot examples illustrated in FIGS. 2, 3 and 4 to a user. The system 800 may include one or more user or client computer systems 802 or similar systems or devices.

The client computer system 802 may include a system memory or local file system 804. The system memory 804 may include a read only memory (ROM) and a random access memory (RAM). The ROM may include a basic input/output system (BIOS). The BIOS may contain basic routines that help to transfer information between elements or components of the computer system 802. The RAM or system memory 804 may contain an operating system 806 to control overall operation of the computer system 802. The RAM may also include a browser 808 or web browser to access remote applications or the like such as a system and method to project staffing needs that may reside on a remote server or system. The RAM may also include data structures 810 or computer-executable code to project staffing needs or the like that may be similar or include elements of the methods 100, 500, 600 and 700 of FIGS. 1, 5, 6 and 7, respectively or some or all of the elements of these methods may reside on a remote server or system as just described. The RAM may further include other application programs 812, other program modules, data, files and the like for other purposes or functions.

The computer system 802 may also include a processor or processing unit 814 to control operations of the other components of the computer system 802. The operating system 806, browser 808, data structures 810 and other program modules 812 may be operable on the processor 814. The processor 814 may be coupled to the memory system 804 and other components of the computer system 802 by a system bus 816.

The computer system 802 may also include multiple input devices, output devices or combination input/output devices 818. Each input/output device 818 may be coupled to the system bus 816 by an input/output interface (not shown in FIG. 8). The input and output devices or combination I/O devices 818 permit a user to operate and interface with the computer system 802 and to control operation of the browser 808 and data structures 810 to access, operate and control the automated risk management system. The I/O devices 818 may include a keyboard and computer pointing device or the like to perform the operations discussed herein, such as the click events.

The I/O devices 818 may also include disk drives, optical, mechanical, magnetic, or infrared input/output devices, modems or the like. The I/O devices 818 may be used to access a medium 820. The medium 820 may contain, store, communicate or transport computer-readable or computer-executable instructions or other information for use by or in connection with a system, such as the computer systems 802.

The computer system 802 may also include or be connected other devices, such as a display or monitor 822. The monitor 822 may be used to permit the user to interface with the computer system 802. The monitor 822 may present the images 200, 300, and 400, web pages or screen shots represented in FIGS. 200-400 to a user or staffing decision maker that may be generated by the data structures 810 to project staffing needs.

The computer system 802 may also include a hard disk drive 824. The hard drive 824 may be coupled to the system bus 816 by a hard drive interface (not shown in FIG. 3). The hard drive 824 may also form part of the local file system or system memory 804. Programs, software and data may be transferred and exchanged between the system memory 804 and the hard drive 824 for operation of the computer system 802.

The computer systems 802 may communicate with a remote server 826 or system and may access other servers or other computer systems (not shown) similar to computer system 802 via a network 828. The computer systems 802 may also access a database 829 that may contain proactive protocols similar to those determined in method 700 of FIG. 7. The system bus 816 may be coupled to the network 828 by a network interface 830. The network interface 830 may be a modem, Ethernet card, router, gateway or the like for coupling to the network 828. The coupling may be a wired connection or wireless. The network 828 may be the Internet, private network, an intranet or the like.

The server 826 may also include a system memory 832 that include a file system, ROM, RAM and the like. The system memory 832 may include an operating system 834 similar to operating system 806 in computer systems 802. The system memory 832 may also include data structures 836 to project staffing needs or the like. The data structures 836 may include operations similar to those described with respect to methods 100, 500, 600 and 700 in FIGS. 1, 5, 6 and 7. As previously discussed, all or portions of the operations associated with methods 100, 500, 600 and 700 may be performed by the server 826 and the computer systems 802. The computer systems 802 may access the server 826 and the data structures 836 via the browser 808 and network 828 to project staffing needs similar that previously discussed.

The server system memory 332 may also include proactive protocols 838 similar to those determined in method 700 of FIG. 7. Alternatively, the proactive protocols may be stored in the database 829, as previously discussed. The server system memory 832 may also include other files 840, applications, modules and the like for other purposes or to perform other operations.

The server 826 may also include a processor 842 or a processing unit to control operation of other devices in the server 826. The server 826 may also include I/O device 844. The I/O devices 844 may be similar to I/O devices 818 of computer systems 802. The server 826 may further include other devices 846, such as a monitor or the like, to provide an interface along with the I/O devices 844 to the server 826. The server 826 may also include a hard disk drive 848. A system bus 850 may connect the different components of the server 826. A network interface 852 may couple the server 826 to the network 828 via the system bus 848.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to project staffing needs, comprising:
predetermining an optimal prediction method for predicting staffing needs from a plurality of prediction methods based on at least one of a center, a target day in a forecasting horizon and a time interval using historical data; and
predicting future staffing needs for at least one of a selected center, a selected target day and a selected time interval by using the predetermined optimal prediction method for the at least one of selected center, selected target day and selected time interval.

2. The method of claim 1, further comprising predicting no-shows of prescheduled staff for the at least one of selected center, selected target day and selected time interval using a predetermined optimal method for predicting no-shows.

3. The method of claim 1, further comprising calculating an expected number of staff members to be present for the at least one of selected center, selected target day and selected time interval by subtracting a no-show prediction from a prescheduled number of staff members.

4. The method of claim 3, further comprising:
determining a no-show prediction for each prescheduled staff member based on historical attendance data for each staff member; and
calculating a predicted number of no-shows for the at least one of selected center, selected target day and selected time interval by adding the no-show prediction for each individual staff member scheduled.

5. The method of claim 1, further comprising determining any predicted staffing shortage or overage by comparing the predicted staffing needs to an expected number of staff members to be present.

6. The method of claim 1, further comprising:
presenting a proactive protocol in response to the center, day in horizon, time interval, skill, and size of a predicted staffing shortage; and
presenting a different proactive protocol in response to the center, day in horizon, time interval, skill, and size of a predicted staffing overage.

7. The method of claim 1, further comprising presenting a list of staff members fitting a selected criteria in response to a predicted staffing shortage.

8. The method of claim 1, further comprising monitoring an accuracy of predicting the staffing needs by comparing the predicted staffing needs to actual staffing needs.

9. The method of claim 8, further comprising generating an alert in response to any predetermined optimal prediction methods falling outside of a predetermined acceptable range.

10. The method of claim 8, further comprising re-evaluating any predetermined optimal prediction method in response to any prediction method falling outside of a predetermined acceptable range.

11. The method of claim 1, further comprising determining an optimal prediction method for predicting a quantity of production units by type of unit based on at least one of the center, time interval and target day.

12. The method of claim 11, wherein determining an optimal prediction method for predicting the quantity of production units comprises:
obtaining historical data for the center for a predetermined time period;
identifying any special days;
calculating an overall daily average number of production units by type for the center;
calculating an average number of production units by day of the week (DOW) over the predetermined time period;
calculating a DOW factor for each DOW by dividing the average number of production units by the overall daily average number of production units;
calculating trend predictor candidates based on the previous N days weighted by N weights to represent different trends;
evaluating different candidate prediction methods and combinations of prediction methods to predict staffing needs using the historical data; and
determining the optimal prediction method from all possible combinations of candidate prediction methods as that combination that optimizes a set of predetermined criteria.

13. The method of claim 1, further comprising determining an optimal prediction method for predicting events that may occur by at least one center, target day and time interval.

14. The method of claim 1, further comprising determining an optimum proactive protocol by at least one of center, DOW, time interval and skill of staff.

15. The method of claim 14, wherein determining the optimal proactive protocol comprises optimally balancing a cost of overstaffing and understaffing the center.

16. The method of claim 1, further comprising projecting staffing needs in a health care facility.

17. The method of claim 1, further comprising:
gathering patient prognosis data; and
establishing prediction models based on staff time for each patient during each future time interval of that patient's stay.

18. The method of claim 1, further comprising setting an optimal staff prediction to a predetermined amount in response to the selected target day being a special day.

19. The method of claim 1, further comprising:
determining a plurality of candidate methods for predicting a number of units of production for a chosen center, target day and time interval in response to the chosen day not being a special day; and
determining a plurality of candidate methods for predicting staff time needed by skill for each unit of production by type, target day and time interval.

20. The method of claim 19, further comprising:
determining a plurality of candidate methods for predicting a number of events that require additional staff time above that needed for the number of units of production; and
determining a plurality of candidate methods for predicting staff time needed by skill for each event by type, target day and time interval.

21. The method of claim 20, further comprising determining the optimal prediction method by searching through the candidate methods for the prediction method that optimizes a set of predetermined criteria.

22. The method of claim 1, further comprising predicting staffing need based on the predicted prognosis of each patient on the center and a staff time to meet each patient's needs during future time intervals of that patient's stay.

23. The method of claim 1, further comprising setting the predetermined optimal staffing prediction method to an optimal patient prognosis prediction method in response to the patient prognosis prediction method being superior to an optimal unit/event prediction method when applying a set of predetermined criteria.

24. The method of claim 1, further comprising setting the predetermined optimal staffing prediction method to an optimal unit/event prediction method in response to the unit/event prediction method being superior to an optimal patient prognosis method when applying a set of predetermined criteria.

25. A system to project staffing needs, comprising:
a data structure to predetermine an optimal prediction method for predicting staffing needs from a plurality of prediction methods based on at least one of a center, a target day in a forecasting horizon and a time interval using historical data; and
a data structure to predict future staffing needs for at least one of a selected center, a selected target day and a selected time interval by using the predetermined optimal prediction method for the at least one of selected center, selected target day and selected time interval.

26. The system of claim 25, further comprising a data structure to predict no-shows using a predetermined optimal method for predicting no-shows.

27. The system of claim 25, further comprising a data structure to calculate an expected number of staff members to be present for the at least one of the selected center, the selected target day and the selected time interval by subtracting a no-show prediction from a prescheduled number of staff members.

28. The system of claim 25, further comprising a data structure to determine any predicted staffing shortage or overage by comparing the predicted staffing needs to an expected number of staff members to be present.

29. The system of claim 25, further comprising:
a proactive protocol presentable in response to a predicted staffing shortage; and
a different proactive protocol presentable in response to a predicted staffing overage.

30. The system of claim 25, further comprising a list of staff members fitting a selected criteria being presentable in response to a predicted staffing shortage.

31. The system of claim 25, further comprising a data structure to monitor an accuracy of predicting the staffing needs by comparing the predicted staffing needs to actual staffing needs.

32. The system of claim 31, further comprising a data structure to re-evaluate any predetermined optimal methods in response to any prediction method falling outside of a predetermined acceptable range.

33. The system of claim 25, further comprising a data structure to determine an optimal prediction method for predicting a quantity of production units by type based on at least one of the center, the time interval and the target day.

34. The system of claim 25, wherein the center comprises one of a plurality of centers in a health care facility.

35. The system of claim 25, further comprising:
a plurality of candidate methods for predicting a number of units of production for a chosen center, target day and time interval; and
a plurality of candidate methods for predicting staff time needed by skill for each unit of production by type, target day and time interval.

36. The system of claim 35, further comprising:
a plurality of candidate methods for predicting a number of events that require additional staff time above that needed for the number of units of production; and
a plurality of candidate methods for predicting staff time needed by skill for each event by type, target day and time interval.

37. The system of claim 36, further comprising a data structure to determine the optimal prediction method by searching through the candidate methods for the prediction method that optimizes a set of predetermined criteria.

38. A computer program product to project staffing needs, the computer program product comprising:
a computer readable medium having computer readable program code embodied therein, the computer readable medium comprising:
computer readable program code configured to predetermine an optimal prediction method for predicting staffing needs from a plurality of prediction methods based on at least one of a center, a target day in a forecasting horizon and a time interval using historical data; and
computer readable program code configured to predict future staffing needs for at least one of a selected center, a selected target day and a selected time interval by using the predetermined optimal prediction method for the at least one of selected center, selected target day and selected time interval.

39. The computer program product of claim 38, further comprising computer readable program code configured to calculate an expected number of staff members to be present for the at least one of the selected center, the selected target day and the selected time interval by subtracting a no-show prediction from a prescheduled number of staff members.

40. The computer program product of claim 38, further comprising computer readable program code configured to determine any predicted staffing shortage or overage by comparing the predicted staffing needs to an expected number of staff members to be present.

41. The computer program product of claim 38, further comprising:
computer readable program code configured to present a proactive protocol in response to a predicted staffing shortage; and
computer readable program code configured to present a different proactive protocol in response to a predicted staffing overage.

42. The computer program product of claim 38, further comprising computer readable program code configured to present a list of staff members fitting a selected criteria in response to a predicted staffing shortage.

43. The computer program product of claim 38, further comprising computer readable program code configured to monitor an accuracy of predicting the staffing needs by comparing the predicted staffing needs to actual staffing needs.

44. The computer program product of claim 38, further comprising computer readable program code configured to determine an optimal prediction method for predicting a quantity of production units by type of unit for at least one of the center, time interval and target day.

45. The computer program product of claim 38, further comprising computer readable program code configured to project staffing needs in a healthcare facility.

46. The computer program product of claim 38, further comprising computer readable program code configured to determine the optimal prediction method by searching through a plurality of candidate methods for a prediction method that optimizes a set of predetermined criteria.
